(19) United States
(12) Patent Application Publication
(10) Pub. No.: US 2013/0164720 A1
(43) Pub. Date: Jun. 27, 2013

(54) Career choice methodology

(71) Applicants: Allison Lynne Siimes, Bedminster, NJ (US); Seppo Tapani Siimes, Bedminster, NJ (US)

(72) Inventors: Allison Lynne Siimes, Bedminster, NJ (US); Seppo Tapani Siimes, Bedminster, NJ (US)

(21) Appl. No.: 13/374,315

(22) Filed: Dec. 21, 2011

(51) Int. Cl. G09B 19/00

(52) U.S. Cl. 434/219

(57) ABSTRACT

A networked site or Internet site serving a portal provides a user with a step-wise process for guiding the user through steps and exercises that teach the user how to think about career direction. The user is guided as to how to properly do research to choose the right direction based on a number of factors. Through an interactive user interface, personality and life priority assessment is conducted, with results optionally being stored in a selection database. The user interacts with an industry database and organization structure database, selecting industries and organizations of interest. A reference tools database/research means is optionally provided for learning more about the selected items. Optionally, a career attribute database links information matching careers, courses of study, and colleges, with user preferences selected. An integration engine matches careers in the career attribute database with criteria identified in the selection database reflecting the user's expressed interests.

### BACKGROUND OF THE INVENTION

1. Field of the Invention

The present invention relates generally to a career choice method; and, more particularly, to a system and method for educating a student as to the organizational and industrial employment opportunities available, while guiding the student in selecting at least one career choice and at least one associated curriculum path that is most compatible with the student's personality and priorities.

2. Description of the Prior Art

Choosing a career direction and subsequent appropriate education, be it college or otherwise, represents a costly investment, destined to become more costly, as tuition costs continue to rise. Unfortunately, young people find it difficult to choose the right career direction and corresponding preparation in education as well as the correct major or curriculum, which can lead to additional costs beyond the normal four-year tuition. Wrong choices lead to transferring to a different college with different requirements, sometimes due to the fact that the college attended does not offer the major upon which the student eventually decides. Ultimately, the student must spend additional semesters in school, as a newly-selected major may involve taking many other courses. As a result, there is additional time spent in school and additional costs, along with the opportunity cost of being unable to work full time.

This problem is so pervasive that according to the College Board, (http://wiki.answers.com/Q/What_is_the_average_length_of_time_to_earn_a_bachelor%27s_degree) the average time to earn a bachelor's degree is 4.7 years (2008) indicating that the trend is toward 5 years. Only 57% of those who start a 4 year degree finish within six years. Of those who do complete a college degree, many will chose an unrelated career or reject their initial career choice. Often this will necessitate a return to school and re-education in a different field.

A young person who can identify a career direction that is right for him or her, early on, along with a relevant college or other preparation, has a distinct economic and psychological advantage. Unfortunately, students do not know how to go about making this choice and there is no complete system or method to guide them in doing so. Students lack the knowledge and information to make a correct decision and do not know how to approach the process. Students need to be exposed to the relevant information, a step-by-step method for identifying a set of proposed choices, relevant methodology as to how to do their own research (step by step), and reinforcement exercises for ensuring the methodology, learnings and information are well understood. Students need an all-inclusive portal for career guidance; which provides a feedback loop for eliminating careers, which are not of interest, and for focusing research on those that are. In this way, students successively narrow their choices, until those which fit best with their personalities and priorities are investigated by them, utilizing the steps in the methodology, and linked to an appropriate set of proposed colleges and courses of study. Students need to learn a methodology for career selection and for making life choices.

### SUMMARY OF THE INVENTION

The above objectives of selecting a set of proposed careers, and appropriate preparation are achieved in a method, system, and computer program product. The computer program product is a program for carrying out the steps of the method and the computer system is a networked portal, which also carries out the steps of the method.

The method implements a networked site or Internet site serving a portal that provides the user with a step-wise process for identifying the careers, which best match the user's interests. Through an interactive user interface, the user is directed to a system for personality and life priority assessment, with the results being stored in a selection database. Through the user interface, the user also interacts with an industry database and an organization structure database, selecting those industries and organizations of personal interest, the selections being stored in a selection database. The reference tools database is applied to the selections stored, so that the user can learn more about the selected items and eliminate those, based upon the research, found to be of lesser interest. At any point, the user can access the testing and homework database to practice using the information the user has learned through the career method and ensure the material has been learned.

The career attribute database contains linking information for matching careers, courses of study, and colleges, with the user preferences selected. The integration engine preferably matches the careers in the career attribute database, with the criteria identified in the selection database, such that the matched careers reflect the user's expressed interests. Most preferably, said matching of the careers is performed as part of the research phase by accessing other available content on the system. The integration engine also matches the matched careers with courses of study and colleges. The integration engine returns the results to the user interface.

### BRIEF DESCRIPTION OF THE DRAWINGS

The invention will be more fully understood and further advantages will become apparent when reference is had to the following detailed description of the preferred embodiments of the invention and the accompanying drawing, in which:

FIG. 1 is a block diagram depicting an embodiment of the subject invention;

FIG. 2 is a block diagram depicting operation of a networked computer system in accordance with an embodiment of the invention;

FIG. 4 is a flowchart depicting the elements of the networked computer system in accordance with an embodiment of the invention;

FIG. 4 is a diagram of sample personality, priority, SIC code, NAIC code, organization type, department, and organization structure data for an optional embodiment of the computer system;

FIG. 5 is a diagram of sample career and major data for an optional embodiment of the computer system;

FIG. 6 is a diagram of sample career attributes for an optional embodiment of the computer system; and

FIG. 7 shows a general schematic of an alternative embodiment of the subject invention in operation with a networked computer system;

FIG. 8 illustrates Step 1 of FIG. 7 in detail;

FIG. 9 illustrates Step 2 of FIG. 7 in detail;

FIG. 10 illustrates Step 3 of FIG. 7 in detail;

FIG. 11 illustrates Step 4 of FIG. 7 in detail; and

FIG. 12 illustrates Step 5 of FIG. 7 in detail.

### DETAILED DESCRIPTION OF THE PREFERRED EMBODIMENTS

The present invention encompasses methods, networked computer systems and computer programs that implement a network portal such as an Internet site that assists students in choosing a career. A comprehensive step by step methodology is provided for teaching a user how best to think about appropriate career choices. In accordance with the methodology, there is utilized an interactive set of exercises to guide the user through each of the teachings.

For each step, there are teachings, techniques, exercises, and homework to assist the student in learning about the choices available and to guide the student to the next step of the methodology. An example of the teachings would include:
1) Learning about yourself−personality and priorities;
2) Learning what all the choices are: (utilize SIC codes or other resources);
3) Learning about organizational structures;
4) How to do your own research;
5) How to take what you've accomplished in steps 1-4 and begin to apply the information for selection/elimination; and
6) How to research your ‘short list’ of choices.

Young people, particularly, are generally exposed to an extremely limited amount of career information and career experience and are ill-equipped to make a clear and intelligent choice. The amount of career information which exists can be overwhelming; the method and system combat this problem by breaking the career choice process into steps, which can be studied and understood, enabling the student to think more clearly about the student's choices. Career changers of any age can benefit from the present invention as many older workers may also know little about the career choices, which have developed since their leaving school, or career choices outside of their work experience.

The teachings, techniques, and exercises will change as the work environment, society, and technology change but may take the form of quizzes, written assignments, readings, videos and the like. In one embodiment, the invention is entirely implemented in a networked portal with readings and assignments in the form of hyperlinked or digitized materials.

However, in an alternate embodiment, for example, portions of the teachings, techniques, and exercises are administered in a traditional classroom setting such as a high school or college semester. Materials include a textbook. Students are grouped according to common factors and the program is tailored to each group's needs. In yet another embodiment, hard-copy materials are bundled with a DVD and or CDs. The invention may also be delivered at a specialized learning center such as a tutoring center.

Choosing a college or career, particularly in one's early years, or even for older adults seeking more self fulfillment, is very important and represents a costly investment with rising tuition costs. Young people graduating from high school, at the age of 17 or 18, find it difficult to choose the right college to attend, and the right major or curriculum to pursue. Inasmuch as choosing the right college is directly relevant to the right major or career path for a young person, the right career choice at this age is critical. With college costs on the rise and the resultant student loan debt looming, choosing the right career path can ensure career enjoyment, increased chance of employment, and financial stability. Most students choose a college and major or college program based on a limited series of facts in their experience to date. This leads many to change careers while still in college—a decision that frequently increases college tuition costs, or may even lead to a career in a field that the person becomes dissatisfied with. Students encountering such career changes may find themselves in a field that does not require use of their college degree or which involve an entirely different line of work altogether. Some people even end up going back to school to be re-educated in a different field, necessitating the expenditure of additional time and money. With the cost of inflation and college and the ever increasing need for student loans reaching well into six figures, a person is at a significant advantage if he/she is equipped to make a strategic determination as to a proper career fit and college. Unfortunately, there is no program, process or method that teaches a person, or young adult, how to choose a career, from a pragmatic standpoint and at the right time, to make a difference. This occurs because young people have only been exposed to an extremely limited amount of information and experience, and therefore they are ill-equipped to make a clear, intelligent choice. Often, they do not even know what the choices consist of, or how to approach the topic. For most people, it's overwhelming. There is a need in the art for a system and/method that breaks the steps down in a way that a person can understand and think more clearly when determining the right career and college. The term “student” as used herein is understood to mean a person of any age that is engaged in scholastic endeavors.

The present invention provides a method and system wherein the key elements to be considered in career selection for a user can be created from their industry choices, their personality elements and their priorities. The end result of the subject method and system is to narrow down the career selection to at least two lists—Industries and Disciplines.

Preferably, the present invention includes the ability to incorporate pop-up advertisements and/or links and/or live links and/or promotional material within the system. The pop-up and/or advertisements or links are preferably directly related to the specific step being carried out by the system and provide the ability for the method provider to generate capital through selling the pop-up or advertising space. In terms of “colleges” and “job research” areas provided by the subject system to the user, when the user is presented with same, pop-ups and/or advertisements and/or links to specific colleges, etc., may be provided listing various colleges or jobs when the program deems a choice/match. For example, a set of careers may be short listed in the program. Then, a short list of matching colleges may appear, with pop-ups and/or live links to those specific college sites. This feature provides a huge value to the program provider and the college. Same would apply with job listings/company pop-ups. The pop-up or link is preferably provided as an ability for colleges, job boards, etc. to live link once a short list is determined.

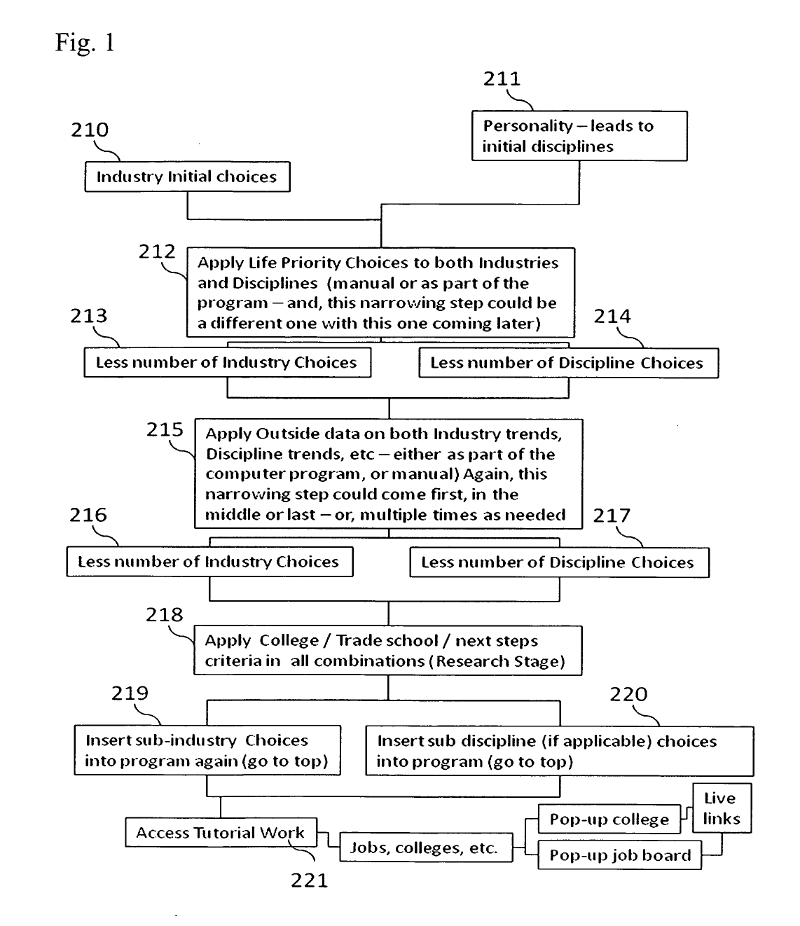

Referring now to FIG. 1, a block diagram in accordance with an embodiment of the invention is shown. Note that it is to be understood that the following steps, especially the first and second hereinafter, can be carried out in any order without departing from the scope of the subject invention. In Industry Initial Choices Step 210 first, the user looks at the Industry listing of SIC codes (along with some tutorial learning content/exercises). The user then checks the boxes that he/she is interested in. This will yield multiple choices of industry choices (for example as many as 15 choices may be yielded). A pop up box for viewing sub-industries is also preferably provided. Second, the user takes the personality test(s) 211, which will yield one or more types of personalities (3 for example), along with suggested disciplines for each of the personalities (10 for example). Third, the user fills out selections—or considers—life choices/priorities on a number of questions as shown at 212. This yields a series of criteria that the user feels are important for them. This priority criteria is applied to both the initial industry selections and initial discipline selections, hence narrowing the choices for both tracks as shown at 213, 214, respectively. Ideally, this is executed as part of the subject program or method, but it may instead be left up to the user. This can be done as the initial narrowing step, or later in the process, and may be done numerous times.

‘Narrowing steps’ may include other criteria besides just priorities, outside data on industries and disciplines, depending on what makes sense to incorporate into the program. Fourth, outside industry trending data, growth of industry data, discipline trending data, and any other relevant outside data elements are applied to both industries and disciplines, either by the computer program, or manual; the results are provided, as shown at 215. This results in a smaller list of industries and disciplines the user may be suitable for, as shown at 216, 217, respectively. In this manner, the fifteen industries may now be narrowed down to five; The list of disciplines may now be five instead of ten. Again, this narrowing step can be carried out at any point in the process, and may be performed numerous times. Fifth, the education/trade school/next step/college lists are applied to this smaller selection in every combination of industry with discipline as shown at 218. Insert sub-industry Choices Step into the program again (go to 210) is provided at 219. Insert sub discipline (if applicable) choices into program (go to 211) is provided at 220.

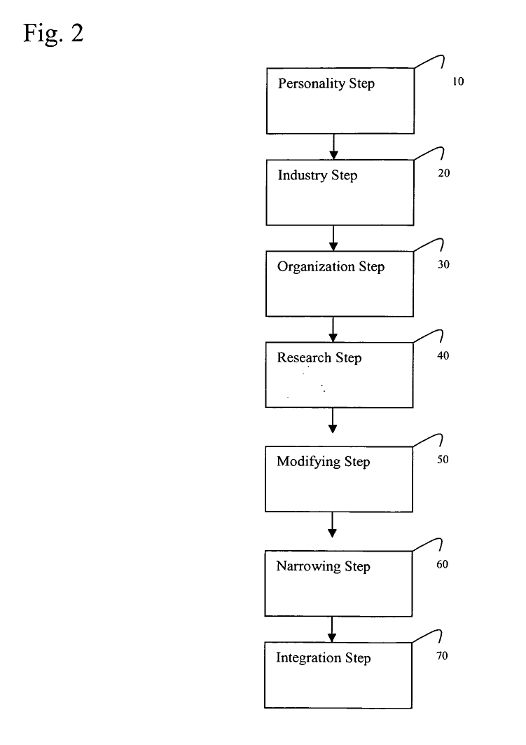

Separate to everything listed above, there are ‘tutorials’ 221 on the following topics (these may be pop-ups that are accessible throughout the above mentioned steps). For example, if a user X wanted to see the skills sets required for a given discipline as described above, then a pop up could provide that. Each of the tutorials will have specific exercises to help the user learn. Tutorials preferably include:
1) Skill sets—when a user wants to know more details about a skill set that is associated with a particular discipline;
2) Research—The key here is to learn how to do research about a given industry, discipline or college by learning how to research that industry, discipline or college properly (who to talk with, what to ask, where to find more info, etc). One example of a pop up box would be to see the companies that are in a given industry, for example (Telecom: ATT, Verizon, Etc) along with some basic metrics. Other research modules may include resources on job hunting, etc.;
3) Interviewing skills—There are two aspects to this. One is the interviewing skills a user needs to learn to best do the research as mentioned above. The other is the interviewing skills needed to find a job in the industry and discipline once defined; and
4) Goal setting—A tutorial on goal setting best practices, techniques, etc. Referring now to FIG. 2, a block diagram in accordance with an embodiment of the invention is shown. In Personality Step 10 the user takes the Meyers-Briggs Assessment (MBTI) or equivalent and the user's personality type is established. So for example, the user may be an ISTJ (introversion-sensing-thinking-judgment) or one of the other 15 personality types. Once this is established, through teaching exercises, the user receives instruction in understanding the user's personality type. In an alternate embodiment, another assessment tool, for example the Keirsey Temperament Assessment or other resources, is used. In additional teaching exercises, the user practices interacting, active listening skills, team building, and other related skills. Still other tests of this kind may be substituted in alternate embodiments.

Additionally, in Personality Step 10, the user's life priorities are assessed. These priorities include items such as self-care, respect, family, income, free time, and the like. Priorities may be identified from a list the user creates, from standard lists, or from exercises such forced choice or a grading/gauging exercise. Through the teaching exercises, the user is instructed in the connection between career choice and life priorities.

Industry Step 20 acquaints users with industries described in Standard Industrial Classification (SIC) codes, North American Industry Classification System (NAICS) codes, or other standard industry codes. These are available through the WARDS Business Directory or links to websites and are downloadable for local storage. An example of an NAIC code is 52 representing Finance and Insurance; an example of an SIC code is 6199 representing Financial Services. Industry Step 20 allows users to view all the industries and employment areas available. A series of exercises guides the user in how best to absorb this amount of overwhelming information and make effective use of it.

Through a series of exercises, student choices for personality type and priorities, developed in Personality Step 10, are matched with one or more industries described in Industry Step 20. In an alternate embodiment, the student may do the matching manually. So for example, if a user expresses a preference for high income and has a personality of type ESTJ (extraverted-sensing-thinking-judgment), one option would be to work in an industry such as SIC code 6299 (finance services) and NAIC code 52 (finance and insurance). In this way, Narrowing Step 60 enables the user to eliminate industries, which are unsuitable for the user's personality and priorities. Likewise, if the user has a personality of ISTJ (introverted-sensing-thinking-judgment) and has services as a priority, one option would be to work in an industry such as SIC code 8011 (clinics) and NAIC code 62 (health care). Industries selected may be ranked according to preference. The selections may be adjusted by the user.

In Organization Step 30, the user learns about corporate organizational structure, focusing on what is common in most companies and what is unique. Some examples of common organizations structures include departments such as finance and sales. Specialized industries such as hospitals have these departments and well as others unique to the industry such as critical care and general surgery. In this way, users learn not just about an industry, as designated by SIC and NAIC codes, but also about disciplines within the industries. Users also learn about the differences between government-funded occupations and occupations in the private sector as well as highly specialized industries such as music and theater. Users are also instructed about risk, benefits, pros, and cons, of each industry. In Organization Step 30, instruction is specialized and tailored to the user because Narrowing Step 60 may have eliminated some choices, already, and these need not be presented. Further narrowing may take place in Organization Step 30 as Narrowing Step 50 is re-executed. Organizations selected may be ranked according to preference and selections modified by the user.

In Application of Other Outside Data Step 40, the user researches the industries and organizations, which have not been eliminated in Narrowing Step 60. Exercises and techniques inform the user as to the appropriate research tools and how to use them. Links are provided for Internet information of all kinds, professional organizations in fields of interest, and trade journals. Application of Other Outside Data Step 40 also teaches the users how to engage others in the field(s) of choice, interviewing as an interviewee and/or interviewer, whom to call, how to make appointments, networking skills, questioning skills and similar tools designed to lead to students achieving career goals.

Modifying Step 50 enables the user to modify the user's preference rating of industries and organizations of interest based upon the research of Application of Other Outside Data Step 40. After examining attributes of selection such as pay grades, nature of work, lifestyle, priorities, etc. identified in Application of Other Outside Data Step 40, the user may decide that some career choices are less or more interesting than first thought. The user may also re-execute Narrowing Step 60 to eliminate additional organizations or industries formerly selected. Typically there does not exist a single narrowing step. Each step in the methodology has consideration and narrowing aspects. The methodology is an iterative process throughout.

In Integration Step 70, the user already has the user's choices narrowed down and priority rated. Exercises and assignments in Integration Step 70 teach goal setting and planning so that the user can develop a primary career and multiple secondary career plans. The user utilizes the techniques taught in Application of Other Outside Data Step 40 to choose the right next step, which matches the user's personal priorities, life expectations, and choices identified in Personality Step 10, Industry Step 20, and Organization Step 30, further modified by Narrowing Step 60, Application of Other Outside Data Step 40,and Modifying Step 50. In Integration Step 70, the user identifies at least one career choice, associated majors and colleges or other work experiences, which will help the user in undertaking the chosen career. Results of the method yield more than one career choice, associated majors and colleges or other work experience, or industries and/or disciplines. Multiple choices are preferably provided for a broad selection of possibilities, based on the parameters that were entered. If the user changes the parameters, other choices will appear.

Turning to FIG. 3, User Interface 100 enables the user to interact online with the system. In an alternate embodiment, the user interacts with the system via a traditional classroom setting or in other embodiments via email, writing, and the like. Interaction with the system need not follow a prescribed path or order. Personality Assessment System 120 receives input from the user and guides the user to a customized personality assessment in accordance with the Meyers-Briggs Assessment or other standard personality assessment tool. Optionally, the user's life priorities are also elicited. The personality assessment and life priorities are optionally stored in the Selection Database 180.

The user also selects industries of interest from the Industry Database 130 and organization structures of interest from the Organization Structure Database 140 using the User Interface 100. These selections are optionally stored in the Selection Database 180. The user researches the selections stored in the Selection Database 180 using the Reference Tools Database 150. At each step in the process, the selections in the Selection Database 180 may be narrowed or modified. Also, at each step in the process, through the User Interface 100 the Testing and Homework Database 170 may be accessed for learning about the contents of each database, which optionally leads to narrowing and modifying the selections in the Selection Database 180.

The Integration Engine 110 combines the information from the Career Attribute Database 160 with the selections in the Selection Database 180 to generate a list of careers, courses of study leading to the careers, and institutions of higher education offering the courses of study, which coincide with the user's interests, expressed by the user's selections optionally stored in the Selection Database 180. This information is returned to the user through the User Interface 100.

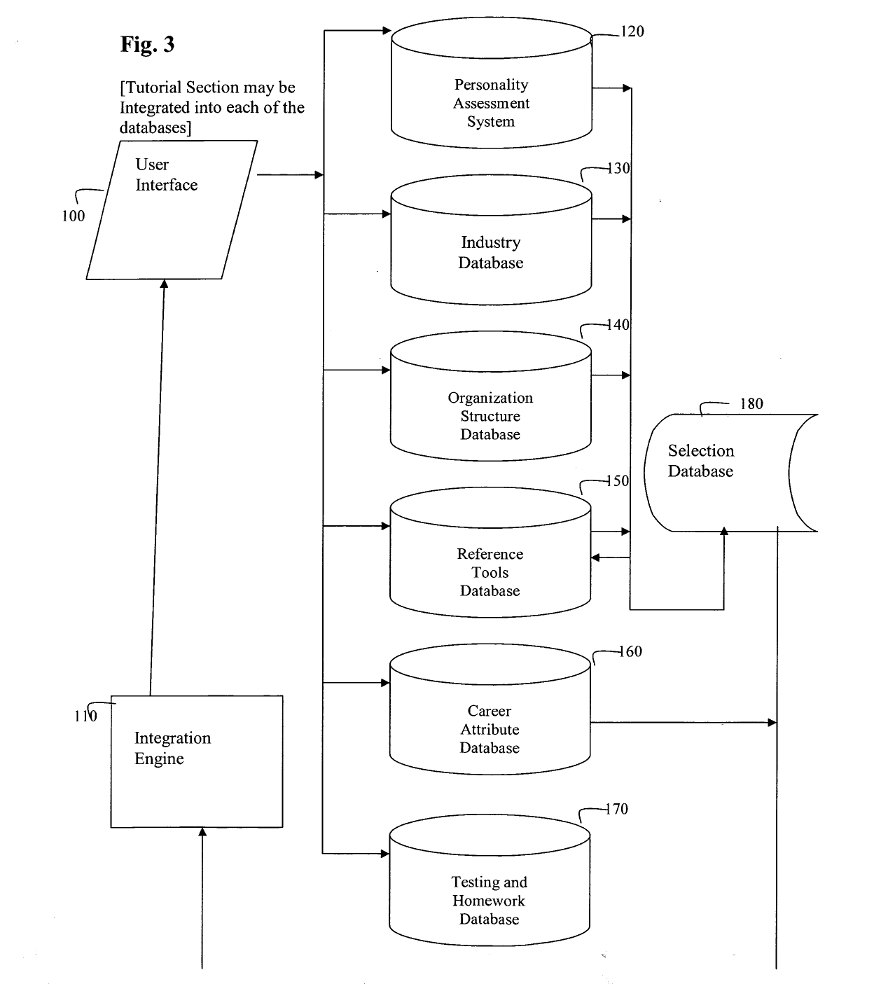

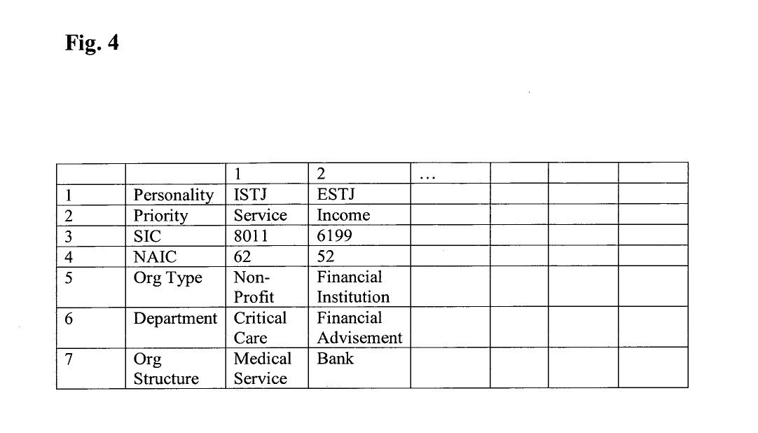

FIG. 4 is a data layout depicting sample personality, priority, SIC code, NAIC code, organization type, department, and organization structure data for an embodiment of the computer system. These data are selected by the user using the User Interface 100 in conjunction with the Personality Assessment System 120, the Industry Database 130, and the Organization Structure Database 140. These data are stored in the Selection Database 180.

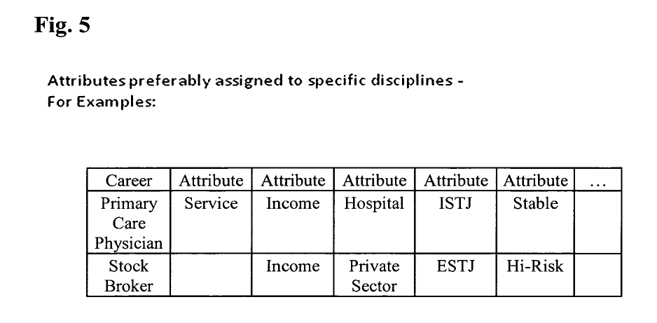

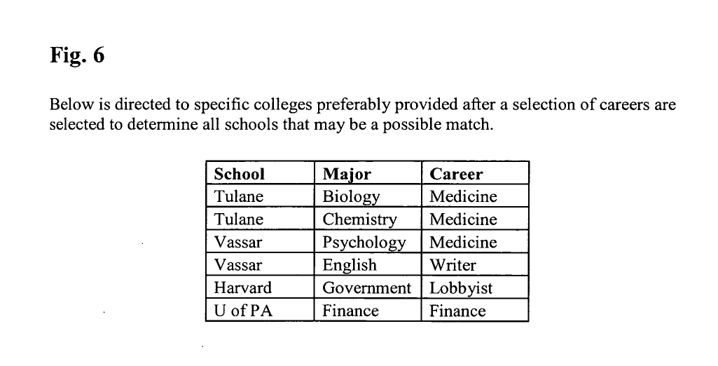

FIG. 5 is a data layout depicting sample college attributes, which in conjunction with sample career and major data shown in FIG. 6, are input to the Integration Engine 110, from the Career Attribute Database 160, to generate a list of careers, courses of study leading to the careers, and institutions of higher education offering the courses of study, which coincide with the user's interests. The Integration Engine 110 optionally generates this output through relational database technology, or object-oriented software, for example.

So, if a user has a personality attribute of ISTJ, selects a low-risk, stable environment, desires to perform service as a high priority, desires to work in a hospital organization and in particular, the medical department, the user is preferably matched with careers, majors, and/or schools, such as medicine as a career, biology as a major, and Tulane as a possible school choice. Preferably, the number of possible career paths will appear, and preferably a number of schools provided. Once a short list of careers and disciplines appears, then the “research” module is appointed to preferably take effect. Other matches, as shown in FIG. 5, would include medicine as a career with chemistry as a major. Alternatively, the student might major in psychology and attend Vassar to reach the same career goal. As another illustrative example, if the user selects the priorities of income and hi-risk, has a personality type of ESTJ, and wants to work in the private sector in a finance department, the user will be matched with the University of Pennsylvania and the finance major and career. The data shown is merely illustrative as numerous possibilities exist and will be updated and modified over time. The fields selected by the user will be increased and decreased in accordance with user selection. The user can change the inputs at will using the User Interface, FIG. 3 100 and generate alternate scenarios.

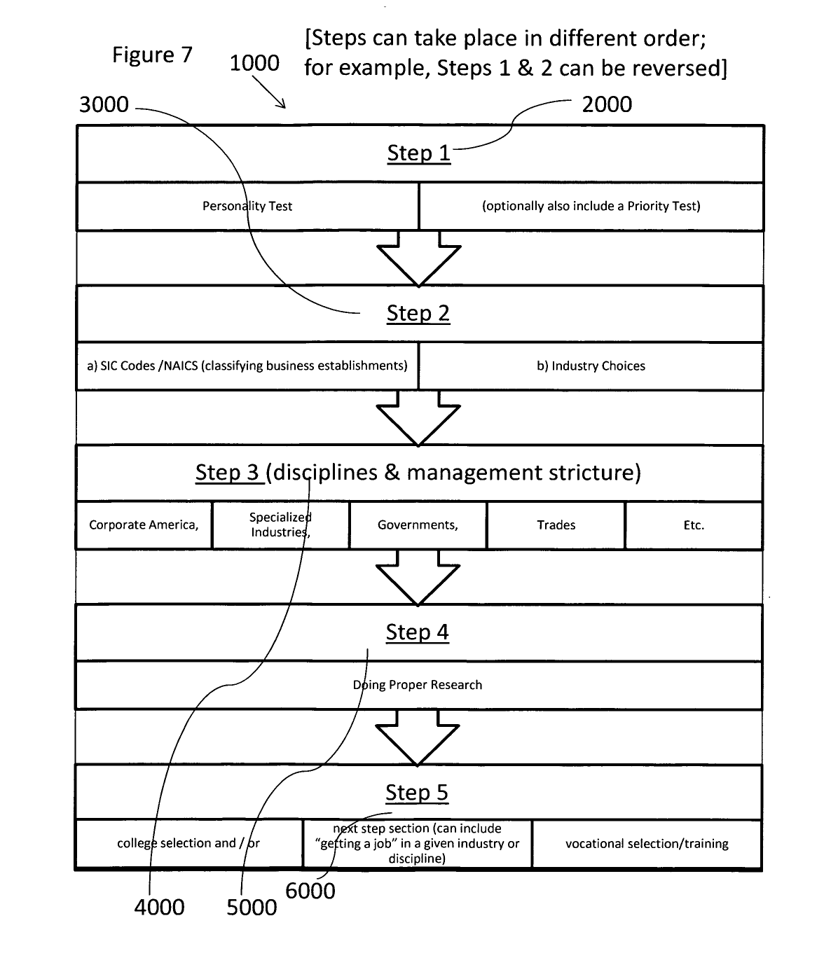

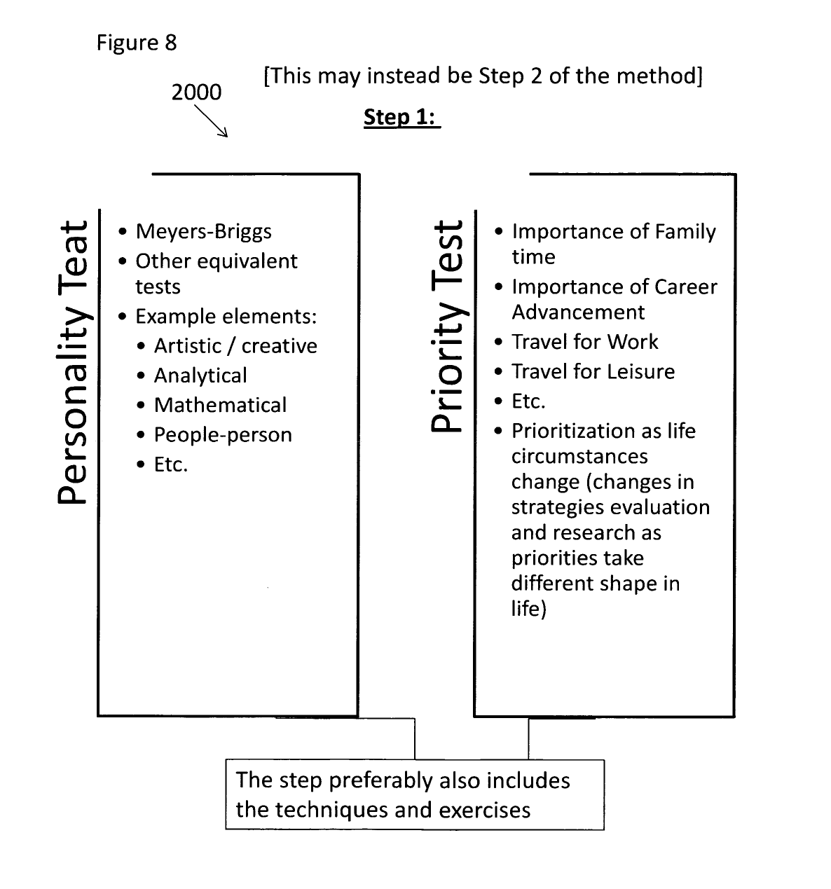

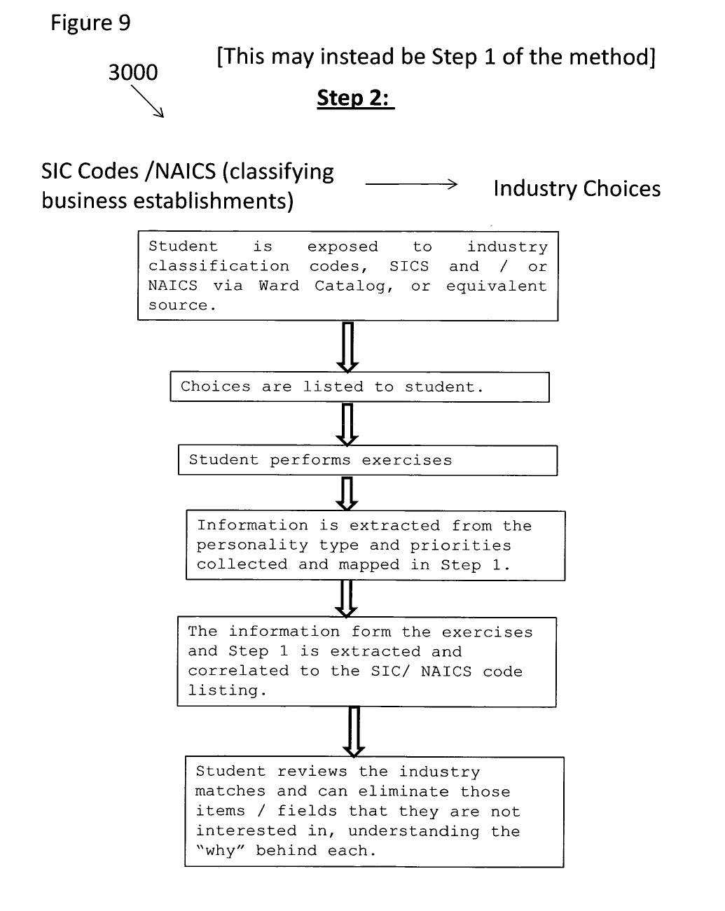

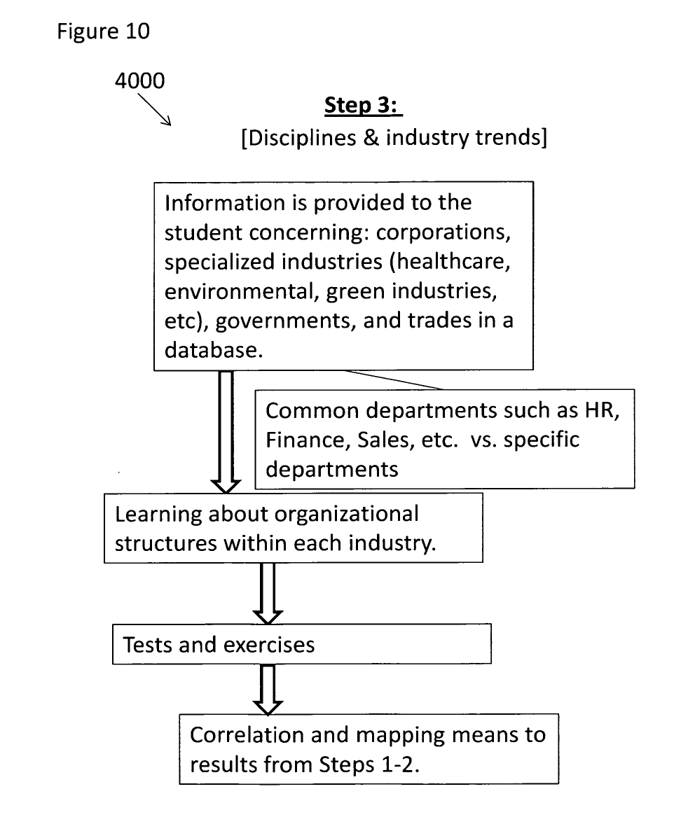

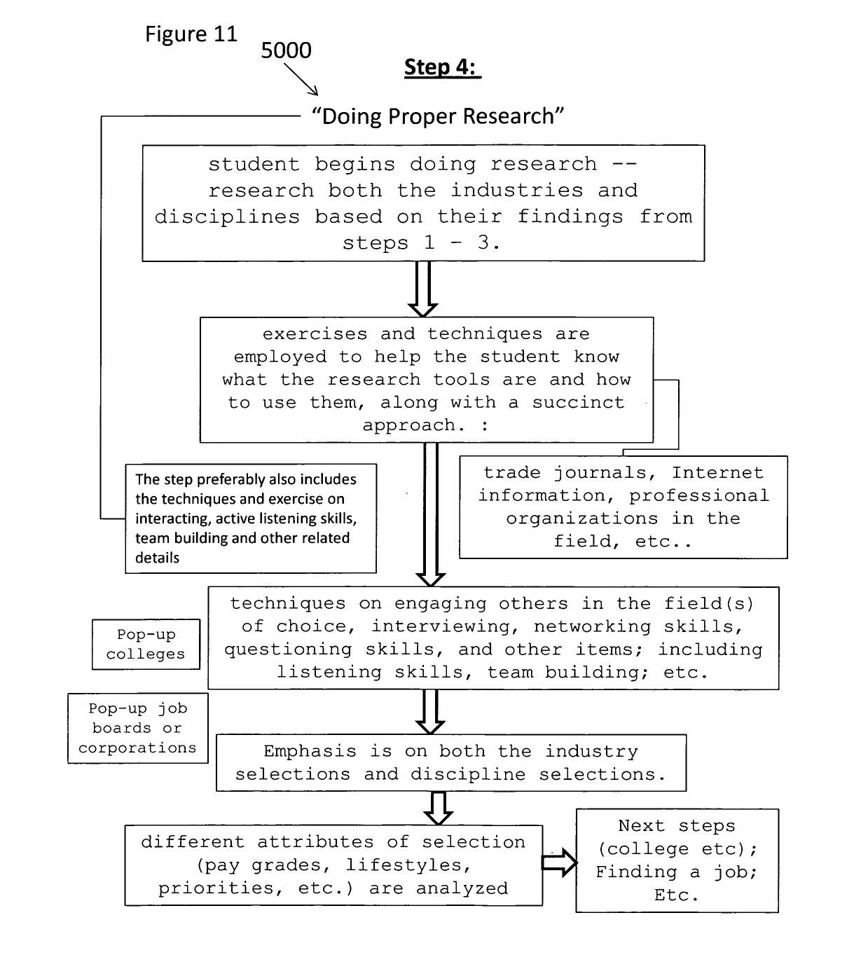

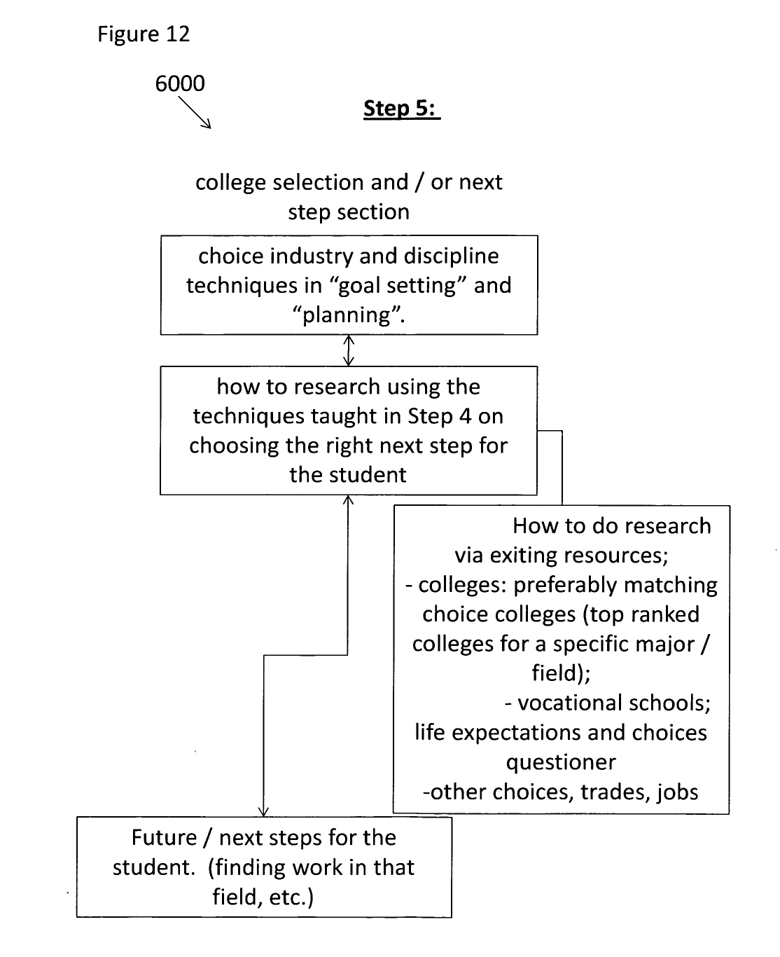

FIG. 7 shows a general schematic of an alternative embodiment of the subject method, shown generally at 1000; FIG. 8 illustrates Step 1 of FIG. 7 in detail, shown generally at 2000; FIG. 9 illustrates Step 2 of FIG. 7 in detail, shown generally at 3000; FIG. 10 illustrates Step 3 of FIG. 7 in detail, shown generally at 4000; FIG. 11 illustrates Step 4 of FIG. 7 in detail, shown generally at 5000; FIG. 12 illustrates Step 5 of FIG. 7 in detail, shown generally at 6000.

Various teachings and techniques may be implemented into the subject method and system without departing from the scope of the invention. For example, the exercises may be modified, as well as the delivery platform. Other program elements may be added to the subject invention, without departing from the scope of the invention, such as for example, elements concerning target audiences, and the progression of technology and cultures. As circumstances change, it is contemplated that the program can readily be expanded with additional program elements, including special tailoring to a specific set of specifications, needs or events. The delivery methods contemplated by the subject invention can vary widely and change over time as technology changes. Examples of delivery methods may include, for example, computer implementation, such as by way of the Internet, live seminars, classroom teachings, videos, CD's or other electronic storage mediums or software, specialized learning, career or tutoring centers, etc. For example, the Internet may be used as the delivery methodology with coursework, interactive online chatting with a mentor or advisor, exercises, tests, techniques available with tests and bundled designs as applicable. Classroom teachings may be used in which live online classes or in person classes may take place wherein teachers in high schools, colleges, and other types of leaning environments or seminars teach the course in a semester style format such as with a text book, etc.

Referring to FIGS. 7-12, note that the steps are not required to take place in any requisite order. Step 1 is shown at 2000 in FIGS. 7 and 8. Step 1 involves a determination of the “personality type” and “priorities” of the person/student; these are determined via personality type and priorities collection and mapping means. For example, the personality type may be determined using a Meyers-Briggs test or analysis, or equivalent testing. The purpose of the Myers-Briggs Type Indicator (MBTI) personality inventory is to make the theory of psychological types described by C. G. Jung understandable and useful in people's lives. The essence of the theory is that much seemingly random variation in the behavior is actually quite orderly and consistent, being due to basic differences in the ways individuals prefer to use their perception and judgment. Other personality tests may be utilized in combination with or separate from the MBTI. By learning one's own personality type and that of others, one can begin to realize his/her strengths, tendencies, talents and limitations. The step preferably also includes the techniques and exercise on interacting, active listening skills, team building and other related details as set forth in FIG. 8. This step also preferably puts an emphasis on priorities, with exercises and techniques that grade and gage life priorities and the connection between career choice and life priorities.

Step 2 of the method requires SIC codes (Standard Industrial Classification List codes) or North American Industry Classification System (NAICS) and industry choices determination means, as shown generally at 3000 in FIGS. 7 and 9. NAICS is currently the standard used by Federal statistical agencies for classifying business establishments for the purpose of collecting, analyzing, and publishing statistical data related to the U.S. business economy. The official 2007 U.S. NAICS Manual includes definitions for each industry, background information, tables showing changes between 2002 and 2007, and a comprehensive index. The official 2007 U.S. NAICS Manual is available in print and on CD-ROM from the National Technical Information Service (NTIS) through the NTIS Web site found at http://www.ntis.gov/products/naics.aspx, for example. In this step, the person/student is exposed to industry classification codes, SICS and/or NAICS for example, and the vast choice of industries. This may be done by using the Ward Catalog, or equivalent source. The key is to look at what all the choices are and engage in a series of exercises designed to take the information from the personality type and priorities leanings and combine them to the SIC code listing. Using these techniques the student can eliminate those items/fields that they are not interested in, understanding the “why” behind each, and more importantly, begin to identify industries they may be interested in.

Step 3 of the subject method includes Corporate America, Specialized Industries, Governments and Trades, shown at 4000 in FIGS. 7 and 10. The key here is learning about industries verses disciplines. This step is appointed to teach about corporate organizational structure—what is common in most companies and what is unique to specific companies/industries. The step is carried out by providing information via corporations, specialized industries (healthcare, environmental, green industries, etc), governments, and trades in a database. Examples are: Departments such as HR, Finance, Sales, etc. are likely common throughout most companies. Specialized industries, such as hospitals, typically include these departments tailored to the specific healthcare industry for example. Learning about organizational structure provides the difference between learning about industries, i.e. the SIC codes, and learning about disciplines within each industry. Other examples include, but are not limited to, government occupations, as opposed to corporations, or examples in the trades, small businesses or the like. This applies also to teachings, techniques and exercises in highly specialized industries such as music, theater, etc. This step also preferably includes directed, specialized and tailored leanings to a specific student, based on their input for Steps 1 and 2. By the implementation of Step 3, the method has facilitated the student into thinking about personality elements and industry and how they relate to one another, with tests and exercises designed to help a student think through each aspect: 1) personality: who am I?; 2) priorities: what is most important to me?; 3) industries: what the choices are; 4) disciplines: both common and specialized; 5) risks (included in step 3): access risks, benefits, pros, cons, employment prospects (supply/demand), average salary ranges (starting, mid-career, senior) etc.

Step 4 of the subject embodiment includes a research step—“Doing Proper Research”, shown generally at 5000 in FIGS. 7 and 11. In this step the student begins doing research that is specific to them, research both the industries and disciplines based on their findings from steps 1-3. First the student needs to understand how to do the research properly. Exercises and techniques are employed to help the student know what the research tools are and how to use them, along with a succinct approach. Some non-limiting examples are: trade journals, Internet information of all kinds, professional organizations in the field, etc. This step also teaches techniques on engaging others in the field(s) of choice, interviewing (how a student can conduct their own interviews, including who to call, how to make appointments), networking skills, questioning skills, and other items. Emphasis is on both the industry selections and discipline selections. This step builds on the previous steps 1-3. The goal of this step is for the student to know how to take their industry and discipline selections and begin doing real research to further identify what they might choose for a career path. In this step, different attributes of selection (pay grades, lifestyles, priorities, etc.) are analyzed.

Step 5 is illustrated at 6000 in FIG. 7 and FIG. 12. Step 5 involves a “college selection and/or next step section”. At this step, the student has their choice industry and discipline more identified and narrowed down. For this step, the student is taught techniques in “goal setting” and “planning”. How to set proper goals and have a primary plan and multiple secondary plans are outlined. Additionally, this step addresses how to research using the techniques taught in Step 4 on choosing the right next step for the student, be it choosing colleges that are a best fit for their personal priorities, life expectations and choices, or whatever next steps are right for the student. The course or method of the subject invention is personalized for each person/student at this phase. This step also preferably includes teaching on strategies for altering goals and plans based on changing circumstances.

The subject invention can be taught in a seminar style for example over three days and to focus groups, etc. The method can be developed with extensive elements in more detail around any of the detailed sub-elements. For example, more detail around goals, assessing risks, evaluating pay scales or growth in an industry or discipline, listening, questioning and interviewing skills, etc. are contemplated. Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. In a computer system, a method for career choices comprising:
a personality step for selecting at least one personality type based upon a test;
an industry step for selecting at least one industry based upon a first preference rating;
an organization step for selecting at least one organizational structure and discipline based upon a second preference rating;
an application of other outside data step for identifying information related to the industry and the organizational structure;
a modifying step for modifying the first preference rating and the second preference rating based upon the information;
a narrowing step for deselecting one or more of the selected industry/industries and the selected disciplines if the first preference rating or second preference rating falls below an identified minimum; and
an integration step for identifying at least one career with a plurality of attributes matching the at least one personality selected, the at least one industry selected, and the at least one discipline.

2. The method as claimed in claim 1 wherein the career is matched with at least one higher educational institution offering an option as to a program of study associated with the career.

3. The method as claimed in claim 1 comprising the steps in the order named.

4. The method as claimed in claim 1 wherein the personality type is selected from a list of standard personality types.

5. The method as claimed in claim 1 wherein the industry is selected from a list of standard industry identifiers.

6. The method as claimed in claim 1 wherein the disciplines within an organization structure are selected from a list of standard disciplines within said organization structures.

7. The method as claimed in claim 1 wherein a student is a selector.

8. The method as claimed in claim 1 wherein a selector performs the selection in response to a series of questions.

9. The method as claimed in claim 1 wherein the personality type is selected by a selector using resource materials that comprise the Meyers-Brigg Type Indicator (MBTI) assessment.

10. The method as claimed in claim 1 wherein the industry is selected from resource materials that comprise the Standard Industrial Classification (SIC).

11. The method as claimed in claim 1 wherein the organization structure is selected from a list of standard organization structures and lessons to help the user carry out the proper research into specialized fields.

12. The method as claimed in claim 1 wherein the personality step further comprises at least one teaching step for instructing a selector about the at least one personality type.

13. The method as claimed in claim 12 wherein the personality step further comprises at least one testing step for testing a selector on content of the instruction.

14. The method as claimed in claim 12 wherein the personality step further comprises at least one homework step requiring the selector to answer, asynchronous with the time of the instruction and subsequent to the instruction, at least one question related to the content of the instruction.

15. The method as claimed in claim 1 wherein the industry step further comprises at least one teaching step for instructing a selector about the at least one industry type.

16. The method as claimed in claim 15 wherein the industry step further comprises at least one testing step for testing the selector on content of the instruction.

17. The method as claimed in claim 15 wherein the industry step further comprises at least one homework step requiring the selector to answer, asynchronous with the time of the instruction and subsequent to the instruction, at least one question related to the content of the instruction.

18. The method as claimed in claim 1 wherein the organization step further comprises at least one teaching step for instructing a selector about the at least one organization structure.

19. The method as claimed in claim 18 wherein the organization step further comprises at least one testing step for testing the selector on content of the instruction.

20. The method as claimed in claim 18 wherein the organization step further comprises at least one homework step requiring the selector to answer, asynchronous with the time of the instruction and subsequent to the instruction, at least one question related to the content of the instruction.

21. The method as claimed in claim 1 wherein the Application of Other Outside Data step further comprises at least one teaching step for instructing a selector about the at least one research tool.

22. The method as claimed in claim 21 wherein the Application of Other Outside Data step further comprises at least one testing step for testing the selector on content of the instruction.

23. The method as claimed in claim 21 wherein the Application of Other Outside Data step further comprises at
least one homework step requiring the selector to answer, asynchronous with the time of the instruction and subsequent to the instruction, at least one question related to the content of the instruction.

24. The method as claimed in claim 7 wherein instruction of the student takes place in a classroom setting.

25. The method as claimed in claim 7 wherein instruction takes place over a medium that comprises the Internet, classroom, textbook, CD, DVD, CD-ROM or the like.

26. The method as claimed in claim 1 wherein the personality step further comprises a priority step for selecting at least one life priority from a personal priority checklist.

27. The method as claimed in claim 1 further comprising an education step for selecting an institution of higher education offering a program of instruction in the career selected.

29. The method as claimed in claim 1 wherein the industry is selected from resource materials that comprise the Standard Industrial Classification List.

30. The method as claimed in claim 7 wherein the instruction takes place using digital multimedia materials.

31. The method as claimed in claim 1 wherein the industry is selected from resource materials that comprise the North American Industry Classification (NAIC).

32. A method as claimed in claim 1 wherein the additional information is generated from a method comprising a keyword search.

33. The method as claimed in claim 32 wherein the keyword search is automatic.

34. The method as claimed in claim 1 wherein a selector modifies at least one of the first preference rating or the second preference rating.

35. The method as claimed in claim 1 comprising a plurality of pop-up advertisement and/or link and/or promotional material within at least one step of said method, wherein said pop-up advertisement and/or link and/or promotional material is specifically related to said step.

36. A computer portal system for career choice for a user comprising:
a personality assessment system for assessing the user's personality according to a standardized test;
an industry database for educating the user about a plurality of standard industry descriptions;
an organization structure database for educating the user about a plurality of organization structures and disciplines;
a career attribute database for educating a user about a plurality of careers;
a reference tool collection for linking to information referring to the industry database, the organization structure database, and the career attribute database;
an exercise and homework database for enabling the user to study contents of the career attribute database, the industry database, the organization structure database, and the reference tool collection;
a user interface for guiding a user in accessing the career attribute database, the personality assessment system, the industry database, and the organization structure database and selecting at least one item from each;
a selection database for storing the user selections made using the user interface; and
an integration engine for identifying at least one career from the career attribute database having a plurality of attributes matching the at least one personality selected, the at least one industry selected, and the at least one organization structure stored in the selection database.

37. A computer program product comprising a computer usable medium having a computer readable program code embodied therein, said computer readable program code adapted to be executed to implement a method for generating a career choice, said method comprising:
a personality module for selecting at least one personality type based upon a test;
an industry module for selecting at least one industry based upon a first preference rating; an organization module for selecting at least one organizational structure based upon a second preference rating;
an Application of Other Outside Data module for identifying information related to the industry and the organizational structure;
a modifying module for modifying the first preference rating and the second preference rating based upon the information;
a narrowing module for deselecting one or more of the selected industry and the selected organizational structure if the first preference rating or second preference rating falls below an identified minimum; and
an integration module for identifying at least one career with a plurality of attributes matching the at least one personality selected, the at least one industry selected, and the at least one organization structure.

38. A computer program product, as claimed in claim 37, which is accessible from a smart phone.

39. A learning tool, in a computer system, for teaching steps for identifying a career choice comprising:
a) presenting a learner with a standard personality test, such that based on a score on the test, the learner can identify the learner's personality type;
b) presenting the learner with a list of industries from a standard industry listing, such that the learner may identify at least one industry about which the learner would like additional information;
c) presenting the learner with a list of common organization structures such that the learner may identify at least one organization about which the learner would like additional information;
d) storing the at least one industry identified and the at least one organization structure identified, by the learner, in a selection database;
d) providing a career information database from which the learner selects the additional information for the at least one industry identified and the at least one organization structure identified, stored in the selection database
e) presenting the learner with at least one learning exercise related to the at least one industry and at least one organization structure stored; and
f) enabling the learner to modify and integrate information stored in the selection database based upon the learner's identified personality type, the additional information requested by the learner, the at least one learning exercise, and information selected from the career information database, whereby the learner identifies at least one career choice.
